(19) United States
(12) Patent Application Publication
(10) Pub. No.: US 2009/0013308 A1
(43) Pub. Date: Jan. 8, 2009

(54) PROGRAMMING INTERFACE FOR COMPUTER PROGRAMMING

(76) Inventor: Peter Renner, Kurten (DE)

Correspondence Address: NEXSEN PRUET, LLC, P.O. BOX 10648, GREENVILLE, SC, 29603, US

(21) Appl. No.: 12/146,793

(22) Filed: Jun. 26, 2008

(30) Foreign Application Priority Data
Jul. 3, 2007 (EP) 07 012 983.8

(51) Int. Cl. G06F 9/44; G06F 3/048

(52) U.S. Cl. 717/109

(57) ABSTRACT

The invention relates to a computer-aided method and system for imperative programming of computers, having program code comprising a plurality of program instructions, there being keywords in the form of placeholders and contextual menus, having a graphical user interface, wherein it is envisaged substantially according to the invention that program instructions are composed of operations and objects, objects being addressable and operations and objects being selected from menus.

### BACKGROUND OF THE INVENTION

The invention relates to a method and a system for creating program code on the basis of imperative languages. In this type of language the program instructions are executed sequentially. Further, the languages are procedural languages. In procedural languages the instructions are encapsulated in blocks (procedures) in order to avoid undesired interactions between instruction blocks. What is more, the invention utilizes a graphical user interface (GUI). It enables an interaction of the user (man-machine interface), which is also referred to as an operating and observing interface.

In procedural languages, as is the case for example in a widely used language called Visual Basic, the instructions of a procedure can be encapsulated in an initial line and a final line specified by the system, these lines being automatically generated by the system. This can occur in that an event (e.g., a user input) takes place in a graphical object of a visualization interface, so that the framing of the procedure, comprising an initial line and a final line, is automatically generated.

Modern programming languages were made for programmers. As a consequence, programming has become so complicated that it is reserved only for specialists. In addition, the available languages are formalistic. A user who writes a program in such a language must observe a formalism (syntax). If he violates this formalism in creating instructions, syntax errors are displayed. Instructions are not accepted until the syntax errors have been remedied at the cost of much effort. These various programming languages, finally, differ in the language-related formalism used by each. Thus the various programming languages such as Java, C++ and Turbopascal differ in their complicated formalisms.

Manuals for individual programming languages run to many hundreds of pages concerned with instructions and distinctive language syntax. The number of available instructions in the case of complex languages is incomprehensible. Great numbers of independent publications dealing with applications and examples are available. This shows how difficult it has become to transform ideas into computer programs. Finally, program quality depends to a great extent on the ability of the software developer.

Because of the burdensome nature of syntax and the difficulty of finding and applying expedient commands in a concrete programming situation, software developers are to a great extent diverted from their proper programming function. A great part of the intellectual capacity of the software developer is thus guided in a wrong direction, which is useless in terms of the proper objective of mapping or simulating processes in a computer.

### SUMMARY OF THE INVENTION

The object adopted for the invention is to enable the software developer to concentrate fully on the programming function by freeing him of the ballast of language conventions and complicated formalism. What is more, persons in the field of education, school, trades—and also private individuals—who are not trained programmers but might wish to transform their ideas into computer programs are to be led to programming once again. In particular, instruction in information technology in schools is to be reformed so that students are led to programming and in this way the usual application of ready-made programs can be suppressed. Creative challenges elicit hidden talents, promote enjoyment of education and strengthen logic and mathematical understanding.

As set forth in the attached claims, the invention seeks to furnish a programming environment to a circle of persons so as to enable them to transform ideas into programs in a creative way without being specialists. It is envisaged according to the invention that program instructions are composed of operations and objects, objects being addressable and operations and objects being selected from menus. The invention thus points to an approach by which programs can be developed without the memorization of a command set and without the need to type in the program text. The user need no longer be burdened with formalisms (syntax). Syntax errors can no longer arise.

The invention is conceived for language designers for use in the creation of programming interfaces, the programming interfaces visualizing real technical or nontechnical methods or processes. With this programming interface, for example, an industrial process can be controlled or regulated. Thinking is to focus on processual aspects. This new form of programming can be understood as “processual programming.” Program lines are to be created in simple fashion. Their content is easily understood on subsequent reading, in particular by other persons who did not themselves create these program lines. Finally, they are readily editable for the purpose of easy maintenance. The above-listed disadvantages are advantageously remedied in that the program author is enabled to create program code in intuitive fashion and to read and maintain it in simple fashion. The program author no longer thinks formalistically, and it is no longer necessary for him to memorize a command set.

The following terms are employed in the further course of the description:

“Language designer” is the person who develops a programming language on the basis of the invention.

“Software developer” is the person who develops an application on the basis of a programming language corresponding to the invention.

“Operator” is the person who operates an application of a programming language according to the invention.

The basic idea of the invention thus consists first in that program instructions are formed from operations and objects. The mode of thinking in programming is thereby guided into a new direction. In implementing the processual function, a software developer need no longer think about which command he should use next. In contrast, the question he must ask is what operation he needs and with what objects he might wish to perform the operation. Any technical individual conscious of the complexity of modern languages will be incredulously amazed that this is possible.

The invention uses keywords in conjunction with contextual menus in order to select operations and objects for completing an instruction. Objects in the meaning of the invention are carriers of data contents and can be addressed via a distinctive name (address). Objects are frequently grouped into tree structures so that these can be coupled with a path. Objects can be graphical objects, variables, procedures, files, images, databases, interfaces and the like. A program instruction according to the invention can take the following basic form:

>Operation: Path\Object<

Here the two parts, Operation and Path\Object, function as keywords that can be replaced by a specific operation and objects in the further operating process.

It is further envisaged according to the invention, that operations can access object data and operations can influence objects and program sequences. In this way the software developer is given a processual basic idea for orienting his thinking process toward whether he might wish with his planned program module to access object data, access objects directly or controllingly access program sequences. In this way he can in simple fashion select an operation so that the desired function is fulfilled.

An example of working with data is if a measured value is assigned to a graphical output object which may be referred to as a digital display. The effect achieved is that the measured value is displayed in the graphical object on the screen. In this case an operation is needed that can access measured values or data. Displayed is:

>Assign Data: Visu\Diagram\TestScreen\DigitalDisplay. InternalTemp=LVTemperature<

Without going into details, the instruction says in plain language:
The value of the local variable
>LVTemperature<
is assigned to the digital display
>DigitalDisplay<
named
>InternalTemp<
in the diagram
>TestScreen<.
The effect of the assignment is that the value of the variable
>LVTemperature< is automatically displayed.

An instruction in which an operation can directly access an object reads as follows:

>Cause Open: Visu\Diagram. Operate<

Here >Cause Open< is the operation and >Visu\Diagram. Operate< is the object. The effect of this operation is to open the object >Visu\Diagram. Operate< and display it on the screen. Here >Visu\Diagram< is the path and >Operate< is the name of the diagram. Such a diagram is part of the graphical interface. It contains graphical objects called visualization objects.

An instruction that influences the program sequence can be the following:

>Control Call:Component\Parallel. Fill<

Here >Control Call:< is the operation and >Component\Parallel. Fill< is the object. This instruction expresses that a procedure named >Fill< is called, so that the further sequence of the program continues with this component. Here >Component\Parallel< is the path of the object and >Parallel< is the type of the object having the distinctive name >Charge<. Menus, also called contextual menus, advantageously aid in structuring and programming. Once an operation has been selected, the associated menu of objects that is then presented displays only those that make sense at this point.

It is further envisaged according to the invention that objects are associated with categories. These categories are superobjects, objects and subobjects.

Superobjects contain objects, being capable of functioning as containers for objects, as for example diagrams that contain graphical objects, forms having form fields for outputting reports. Superobjects can be files and databases. They can also be interfaces or external devices (environment).

Objects do not contain further objects. Objects can, however, have subobjects associated with them. Objects are carriers of data contents. Objects can be for example graphical objects, variables, constants and program components (procedures), these containing program instructions.

Subobjects are characterized in that they relate to an object or operation, complementing the corresponding operation or object.

What superobjects, objects and subobjects are available to a software developer depends first on how powerful the language available to the software developer is, and second on what objects he has installed. In the special case of a preselected operation, the contextual menu offers only those objects that make sense at this point. In the case of graphical objects, he has available a palette of objects (types) from which he can select one, install it in the interface of a visualization diagram and endow it with a distinctive name. Working with objects in general does not constitute a barrier to the software developer because, using the operation-related contextual menus, he can select from a predefined list of available objects in the contextual menus at the relevant point.

An operation that works with a superobject and a subobject can be the following:

>Cause Open:Visu\Diagram\TestScreen (FullScreen\Yes)

The foregoing instruction says that the diagram named
>TestScreen< (superobject) is opened as a full-screen image.
>Visu\< is the category (visualization diagrams);
>Diagram< is the type designation;
>TestScreen< is the distinctive name (names are written in italics);
>(FullScreen\Yes)< is a subobject, >FullScreen< being the category
and >Yes< a constant with logical 1 as data content.

Here the program author could also have selected from the contextual menu a different constant >No< having logical 0 as data content, so that the diagram would not have been opened in full-screen mode. As can readily be inferred, >Diagram< is a superobject because it contains further (graphical) objects. The subobject is associated with the superobject as a complement.

Here is an example of an object:

>Visu\Diagram\TestScreen\AnalogDisplay. InternalTemp<

The object has the name >InternalTemp< and belongs to the type of analog displays >AnalogDisplay< and is disposed in the diagram named >TestScreen<.

>Visu\< is the category (visualization);

>Diagram< is the type designation for diagrams;

>TestScreen\< is the distinctive name (names are in italics);

>AnalogDisplay.< is the type designation for analog displays;

>InternalTemp< is the distinctive name of the object (names are in italics).

The category >Visu< appears in bold letters. This special situation will be discussed further on.

Subobjects are an important tool for the language designer because with their aid one can develop strong instructions. Subobjects can relate to a superobject or object or to the performance of an operation. The following example shows an instruction in which the subobject relates to the performance of the operation:

>Cause Open:Report\FinalTest (LVResult)<

The report is a superobject named >FinalTest<. It is opened and is thus visible on the screen. The subobject with the specified variable >LVResult< contains a value that tells whether the operation has taken place successfully or not. Thus >LVResult< is a subobject associated with the operation.

The following example shows an instruction in which a subobject is associated with an object. The task is to retrieve a measured value from an intelligent peripheral measurement acquisition device (acquired with the parameter of a technical process). It is possible to determine at the same time whether this measured value is valid. It could well be that a malfunction is present and is detected by the peripheral device and made available as a binary value. Such an instruction can be

>Assign: Data: Object=Channel\AnalogInput. Temperature (Out: Valid\LVTest)<

The foregoing is not yet complete. The keyword >Object< must still be replaced by finished program text. The function is as follows: The value of the channel object >Channel\AnalogInput. Temperature< is assigned to the Object on the left of the equals sign. The parentheses enclose the subobject >(Valid\LVTest)< in which a binary value is returned by the system, the content of said binary value being whether the measured value of the superobject is valid/invalid. The further task of the software developer in the case of this instruction is to replace the keyword >Object<. The finished instruction can read: >Assign Data: LVMeasuredValue=Channel\AnalogInput. Temperature (Valid\LVTest)<.

Tables are an example of subobjects that relate to a superobject. For example:

Assign Value: AVCell=Visu\Output\Tab.Output (In:Column\3, Row\5) The variable >AVCell< is assigned to the cell at column 3 and row 5 of the table named Output. Subobjects >Column\3< and Row\5< relate to the table object >Visu\Output\Tab.Output<.

In the following example, a subobject is part of an operation:

>Query: If Visu\TestScreen\AnalogDisplay.InternalTemp=<>30<End Query<

The desired function is as follows: A test is performed to ascertain whether the analog display (AnalogDisplay) named >InternalTemp<, which is disposed in the visualization screen named >TestScreen<, is equal to, less than or greater than 30(° C.). Here the keyword is a subobject (=<>). It permits the choice of one operand or a combination. The instruction can read:

>Query: If Visu\TestScreen\AnalogDisplay. InternalTemp=>30<Query<

The operator (=>) is a subobject and relates to the operation. Visu is the category of visualization objects of the graphical user interface. >TestScreen< is the distinctive name of the screen. >AnalogDisplay< is the type designation of the visualization object type analog display. >InternalTemp< is the distinctive name of the analog display object. 30 is a fixed-value object having data content 30. If the comparison is true, the instructions insertable between the two lines of the block instruction are executed. If the comparison is false, the instructions are not executed. The concept of subobjects according to the invention must be viewed in a broad context. Subobjects that relate to the operation can be endowed with the following data contents: arithmetic operation symbols (+, −, *, /), logical operations (and, or, exclusive or, equal to or greater, not equal to, . . . ), functions (logarithm, power, root, trigonometric). There can be objects that are preinstalled in the scope of the language. For example when a data type is to be assigned to a variable. >Assign DataType: AVSetpoint =Integer<. Here >Integer< is an object that is preinstalled and is automatically adopted into the contextual menu. There can be the following alternatives in this menu: >Integer<, >Binary<, >FloatingPoint<, >Text<. In this connection, the function is the data content and simultaneously the object name. A further possibility is a fixed-value object. >Assign Value: AVSetpoint=30<. Here >30< is a fixed value defined in development mode. This fixed value is an object named >30< and having data content 30. >Assign Value: AVSetpoint=On<. Here >On< can be a constant having a data content of logical 1. Alternatively >Off< with a data content of logical 0.

It is envisaged according to the invention, as set forth in Claim 4, that in the process of generating a new instruction, an operation can be selected from a menu. In this way a crude instruction is displayed. It contains the concept of the operation chosen as well as keywords with which menus can be called, so that superobjects, objects and subobjects can be selected in dependence on the type of instruction. Such a crude instruction, generated by creating and selecting an operation, can appear as follows:

>Cause Open: Object<.

The operation is >Cause Open<. The (underlined) keyword Object must now be replaced by a desired object, using a menu that can be called by clicking on Object. The menu will contain those objects that are possible at this exact point. Such objects can be for example files or diagrams of the graphical interface. A further example of a crude instruction can be the following: >Assign Data: Object=Object<. Here >Assign Data:< is the operation. A further example of a crude instruction can be the following: >Query: If Object=<>Object then< >End Query<. Here >Query: If . . . =<> . . . then< is the operation. The two keywords >Object< are objects. The keyword (=<>) is the operand. It is a subobject associated with the operation.

It is envisaged according to the invention that groups of operations are available for the selection of operations, which can enable inquiries (Query), assign data to objects (Assign), work with superobjects (Cause), control program sequences (Control), alter the appearance of objects (Configure). When a new program line is being inserted, the contextual menu can employ the following operation groups:

Query access object data

Assignaccess object data

Cause access superobjects and superobject data

Control access objects

Configure access object properties
At least the following operation groups Query, Assign, Cause and Control should be available. The Configure group would make the language version more powerful. This disposition of a few operation groups makes it easy for the software developer to make a decision. The Query group will be used by the program author if he is directing an inquiry to the system or might wish to retrieve an item of information, for example whether a key has been pressed. Operations of this group assign data to objects. The Assign group will be employed when the program author might wish to assign data to an object, for example to assign a measured value to a display device in a diagram so that the measured value is displayed. The Cause group makes it possible to access superobjects or superobject data directly. The software developer will use these operations when he might wish to alter the state of a superobject (e.g., open/close, start/stop, create/delete) and when he might wish to transfer data sets from one superobject to another. The Control group makes it possible to influence the program sequence. For example by calling a program component, so that the program continues with this component, or by a wait cycle in the program sequence or by a repeat instruction. The Configure group will be used when the program author might wish to alter properties of a graphical object, such as for example its appearance. In summary, the following simple mental associations are needed for selecting a new instruction:

| | | |
|---|---|---|
| Retrieve information | → | Query operation |
| Assign data to an object | → | Assign operation |
| Access superobjects | → | Cause operation |
| Control program sequence | → | Control operation |
| Appearance of an object | → | Configure operation |

It is envisaged according to the invention that the Query operation group has the task of comparing object data, so that a condition is so derived that corresponding instructions are executed if the condition is true and are not executed if the condition is false. If an operation from this group is selected, the crude instruction can read:

>Query If Object <>=Object then<

>End Query<

The function of Query operations is to test whether a value is greater than, smaller than or equal to another value.

A query may read:

>Query If Visu\Diagram\TestScreen\AnalogDisplay.Interna/Temp=>30<

>End Query<

Here >Visu< is the category of visualization objects of the graphical user interface (GUI). >Diagram< is the type designation of a screen of the graphical user interface. >TestScreen< is the distinctive name of the screen. >AnalogDisplay< is the type designation of the analog display type of visualization object. >InternalTemp< is the distinctive name of the analog display object. >30< is a fixed-value object having data content 30. The finished instruction goes as follows in plain language: A test is performed to ascertain whether the analog display (AnalogDisplay) named >InternalTemp<, which is disposed in the diagram named >TestScreen<, is greater than 30(° C.). If the comparison is true, the instructions insertable between the two lines of the block instruction are executed. If the comparison is false, the instructions are not executed.

It is envisaged according to the invention that the Assign operation group has the task of enabling data exchange between objects, whose further functions can be to assign a format or a data type to data. A crude Assign instruction can be as follows: >Assign Value: Object=Object<. If a software developer wishes to display a value, he can generate the following instruction:
>Assign Value: Visu\Diagram\TestScreen\AnalogDisplay.Interna/Temp=AVTemperature<
   In plain language: The value of the variable Temperature is assigned to the visualization object InternalTemp of analog display (AnalogDisplay) type, which is disposed on the visualization screen TestScreen. Here AVTemperature is a variable named Temperature. AV denotes an application variable.

If a software developer wishes to assign a setpoint to an analog output, he can generate the following instruction:
>Assign Value: Channel\AnalogOutput\Cooling=Visu\Diagram.Operate\Knob.Setpoint<
   In this way a specified setpoint is output, for example as a 0 to 20 mA value, so that the value can be specified as setpoint to a controller.

If a software developer wishes to carry out calculations, he can employ the Assign Value operation. Such an instruction can read:

>AssignValue: AVSpeed=LVRotationSpeed*LVWheelDiameter<

Here >AssignValue< is the operation; >AVSpeed<, >LVRotationSpeed< and >LVWheelDiameter< are variable objects. This instruction makes it possible to assign to the variable >AVSpeed< the product of the two variables >LVRotationSpeed< and >LVWheelDiameter<.

A further function of the Assign group can be to assign a data type to variables. Such an instruction can be as follows:

>Assign DataType: AVSetpoint=Integer<

Here >Integer< is an object that is preinstalled and automatically adopted into the contextual menu. There can be the following alternatives in this menu: >Integer<, >Binary<, >FloatingPoint<, >Text<. In this connection, the function is the data content and simultaneously the name of the object.

A further function of the Assign group can be to assign a number format to variables. Such an instruction can read as follows:

>Assign Format: AVSetpoint=Format\###0.0<

This instruction makes it possible to assign a number format to the variable >AVSetpoint<. The chosen formatting says that there are four places to the left of the decimal point and one to the right of the decimal point. One place to the left and one to the right of the decimal point are always displayed.

It is further envisaged according to the invention that the Cause operation group can have the task that superobjects can be opened and closed, that superobjects can be created and deleted, that superobjects can be started and stopped, that a check can be performed to ascertain whether superobjects are present, that superobjects can be copied and inserted, and that superobjects can exchange data contents among themselves. Not all the operation groups enumerated need be used for a special language product. Which operations are employed for a special language product depends on its intended use.

An example of a superobject that can be opened and closed is a parameter diagram. A parameter diagram enables the operator to input parameters for further trials. In this way series of trials can be carried out with different parameters each time. The parameter diagram contains input objects. A software developer can endow the parameter diagram with the objects suitable for his application. The parameter diagram corresponds with parameter files, which again are superobjects in which the parameter data sets are stored.

A further application of a parameter diagram in process engineering can be to input recipes so that the subsequent process can be carried out with this recipe. Such recipes can be metering quantities for mixing processes. The crude instruction for opening a parameter diagram can read:

>Cause Open: Object<

The keyword Object is replaced from a contextual menu with the superobject >ParameterDiagram<. The finished instruction then reads:

>Cause Open: ParameterDiagram<

As a result, the parameter diagram is visible on the screen. The operator can now input parameters. He can save them as a canned file or can directly start a (mixing) process, which is carried out with the parameters input. Further, he can load a known data set, modify it for his current task and resave it as a canned file under a new name. An example of a superobject that can exchange data with another superobject is a parameter diagram and files corresponding thereto, the input parameter data being canned in the files. A crude instruction for saving parameter sets can run as follows:

>Cause Parameter Save: ParFile(LVResult)<

When the instruction is executed in runtime mode, the operator can select a parameter file for >ParFile< or create a new parameter file. The program continues after the operator input. What is stored in the variable >LVResult< is a value that tells whether the instruction was executed correctly. In this example >ParFile< is the superobject. It is the sum of all parameter files corresponding with the parameter diagram. Each individual parameter file contains a data set that was input by an operator in the parameter diagram. The data content of the superobject >ParFile< is parameter files corresponding with this parameter diagram. Accordingly, no menu is required for the parameter file superobject >ParFile< because only one superobject, specified by the language design, is available. It is further envisaged according to the invention, as set forth in Claim 9, that the Control operation group has the task that program components can be called, that there can be wait cycles in the program sequence and that there can be repeat instructions (loops).

The following instruction can be used to call a program component or procedure so that the program continues with the component called:

>Control Call: Component\Sequence\Init<

This instruction says that a >Component< of >Sequence< type named >Init< is called. The contextual menu for the objects of the >Control Call:< operation contains only those component objects that are possible at this point.

An unconditional wait cycle can be inserted into the program sequence with the following instruction:

>Control Wait: Var millisec<

>Control Wait< is the operation. Var is a keyword whose menu presents variables, constants, formulas and fixed values. If a fixed value is to be selected, an input dialog opens, making it possible to input a numerical value (for example 1000). If the keyword Var is replaced, the finished instruction reads >Control Wait: 1000 millisec<

A conditional wait instruction can be the following:

>Control Wait: If Object=Object<

The program sequence is halted only if the contents of both objects are equal. For example, the object on the left of the equals sign can be a switch object and that on the right a constant >Off< with a data content of logical 0, so that the program is halted only as long as the switch is not turned on.

It is further envisaged according to the invention that operations in the Configure operation group enable properties of graphical objects such as size, color, visible/hidden to be altered. If the user selects graphical objects, they can be positioned on the screen and configured with the aid of configuration dialogs (e.g., size, position, colors, etc.). Depending on the scope of the language, these settings can be altered under the program. A language designer can offer these options to programmers by furnishing a Configure operation group. In this way, properties of graphical objects can be altered under the program. Such properties can be size, color, visible/hidden, etc.

The example of a crude instruction can read:

>Configure: Object (Property)=Var<

The finished instruction can read as follows:

Configure Write: Visu\Output\Button. Continue (Visible)=On

This instruction says that the visualization object named >Continue< of object type >Button<, positioned in the visualization screen >Output<, is rendered visible. If it was previously hidden, the object becomes visible after this instruction. >On< is a constant having logical 1 as data content. A software developer can utilize such a property if he might wish to make a button visible only when an operator action is meaningful in terms of the process being controlled. A language designer must provide a clear delimitation from the Assign operation. If for example a signal light is to be turned on, this is brought to the operator's attention by color reversal (for example red/green). This color reversal is associated with the Assign operation because it is associated with the data content On/Off. The choice of colors for the on and off states, however, falls under properties.

According to the invention there are menus for superobjects and objects, wherein the selectable menu items relate to the selected operation and furthermore contain the objects previously installed by the software developer. One such example is graphical objects of a visualization screen. A software developer first creates, as a superobject, a visualization diagram, for example >Visu\Diagram\TestScreen<. He gives this the distinctive name >TestScreen<. On this screen he installs a graphical object of digital display type, >DigitalDisplay<, and gives it the distinctive name >Temp<. In this way, this object is automatically adopted into the menus of the operations that relate to this object. The result can be the following:

>Assign Value: Visu\Diagram\TestScreen\DigitalDisplay.Temp=Var<

The keyword Var must still be replaced by an object.

It is envisaged according to the invention that there are menus for superobjects and objects, wherein the selectable menu items relate to the selected operation and are specified by the language design. Such an instruction can be:

>Assign DataType: AVSetpoint=Integer<

The variable >AVSetpoint< is assigned the data type Integer, so that this variable exhibits no decimal places as long as this data type applies. Here >Integer< is an object that is preinstalled and justified by the language design and is automatically available in the menu. Further alternatives such as >Integer<, >Binary<, >FloatingPoint<, >Text< can appear in the menu. In this connection, the function is the data content and simultaneously the name. These objects relate to and complement the >Assign DataType< operation.

It is envisaged according to the invention that if an object is a file, a directory is displayed instead of a menu in runtime mode, from which directory the user can select a file. Such an example is the following instruction:

>Cause Save: ParFile (LVResult)<

When the instruction is executed in runtime mode, the operator can select a parameter file or create a new parameter file for >ParFile< (parameter file). The program continues after the operator input. What is stored in the variable >LVResult< is a value that tells whether the instruction was correctly executed. Thus the program author can check, in the following instruction, whether the program can continue properly. In this example >ParFile< is the superobject. It is the sum of all parameter files corresponding with the parameter diagram. Each individual parameter file contains a data set that was input in the parameter diagram by an operator. The data content of the superobject >ParFile< is parameter files corresponding with this parameter diagram. Accordingly, no menu is required for the parameter file superobject >ParFile<, because only one superobject specified by the language design is available.

It is envisaged according to the invention, as set forth that there can be block instructions having an initial line and a final line, the block instruction containing an operation and objects that relate to objects contained in the instructions insertable into the block instruction. The following example shows a Query instruction that is a block instruction:

Query If Visu\TestScreen\ToggleSwitch. On/Off. Status=On then

End Query

Query instructions are coupled with other instructions in such fashion that the instructions insertable between the two lines of the Query instruction are executed when the condition is satisfied and are not executed when the test condition is not satisfied.

According to the invention there can be incomplete instructions that contain an operation but no objects. Such incomplete instructions cannot stand alone. They relate to complete instructions that contain an operation and at least one object. For example:

Query If Visu\TestScreen\ToggleSwitch. On/Off. Status=On then

Assign Value: LVA=3

If not then

Assign Value: LVA=10

End Query

The expression, >If not then<, is an incomplete instruction that relates to the instruction >Query If Visu . . . <. It constitutes an alternative operation.

It is envisaged according to the invention, as set forth in that the keyword Var specifies to the user that only variables, formulas, constants or fixed values are replaceable as objects at this point. It falls to the judgment of the language designer to limit the possible number of objects at certain points. This can be accomplished with a special keyword that tells the software developer that only a limited number of objects are available to him here. For example, besides Object, there can also be a keyword Var. It can be employed if only variables, formulas, constants or fixed values can replace the keyword at this point. For example:

Control Wait Var times

This instruction causes the program sequence to be halted at this point as long as it is equal to the value in the variable (in milliseconds). A further example is the crude form of a loop instruction:

>Control Repeat: For Var=from Var to Var step Var<

>End Repeat<

The finished loop instruction can read:

Control Repeat: For LVRun=from 1 to 10 step 1<

>End Repeat<

Here >LVRun< is the run variable (LV stands for local variable). The other values are fixed values that can likewise replace the keyword Var. The run variable >LV [symbol] Run< is the object. The other instances of Var are subobjects and relate to the operation.

It is envisaged according to the invention that a path is associated with the distinctive name of an object if this object is incorporated into a hierarchical structure, which path together with the distinctive name is inserted into the instruction by the replacement of the keyword. Doing this can make the program much easier to maintain and read. Above all when many diagrams having many objects occur in an application. Without a path that identifies the origin of the object, as provided according to the invention, it is very laborious to maintain the program. For example:
>AssignValue: Channel\AnalogOutput. Setpoint=Visu\TestScreen\SlideController.SetpointAdjuster<
   The path for the object on the left of the equals sign is

>Channel\AnalogOutput. Setpoint<

The category is >Channel<, the channel type is >AnalogOutput<, and >Setpoint< is the distinctive name. The path for the object on the right of the equals sign is

>Visu\TestScreen\SlideController.SetpointAdjuster<

The category is >Visu<, the diagram has the distinctive name >TestScreen<, the graphical object type is >SlideController<, and >SetpointAdjuster< is the distinctive name.

It is envisaged according to the invention that after a keyword has been replaced by an instruction segment, there is a highlighted point (e.g., displayed in bold letters) with which the menu used in creating the instruction segment can be recalled. This facilitates maintenance because it makes it easy to replace an object with another object. It can happen that the software developer has selected an incorrect object. To avoid the necessity of deleting the entire instruction and generating it again, it is envisaged that a point in an instruction segment is highlighted. Clicking on the highlighted point recalls the menu with which the instruction segment was created. Such highlighting is indicated by bold letters in the examples. For example:

>Config Write: Visu\TestScreen\LED.20° C. (Visible)=On

Here >Visu<, >Visible< and >On< appear in bold letters so that a different object can be selected by clicking on one of these bold-faced points.

It is envisaged according to the invention that instructions in the form of modules can be created, the individual modules being capable of being endowed with comments (Information lines), the comment lines being automatically adopted into the documentation of the program component and the documentation of the program components being automatically adopted into the documentation of the application program. It should be noted that program quality depends on the work of software developers. The documentation of the program code plays an important role here. A great many programs have already been deprived of value because a subsequent software developer was no longer able to decipher the program code created by a predecessor. The invention aims to improve this situation by providing the software developer with a method for prompting him to think in structured fashion in the form of program modules and to implement this in programs. In the context of processual programming there is a further level called program module. In this way an application program can be structured hierarchically. The topmost level is the application program. The next level comprises program components (procedures), then program modules, and the lowermost level comprises instructions.

A module should comprise one or a plurality of instructions that together perform a sub-function. These sub-functions should relate to the underlying process. Individual modules are to be endowed with comments in the form of Information lines that identify the relationship to the process. The example that follows demonstrates the principle with reference to an Event component that is cyclically called by a timer:

Timer Component ThreePointController

```
>Info: Cyclical call every second<
>Info: Test cabinet temperature against upper limit<
>Query If Channel\AnalogInput. CabinetTemp. >= 37.1 then
      >Assign Value: Channel\DigitalOutput. Cooling = On<
>If not then<
    >Assign Value: Channel\DigitalOutput. Cooling = Off<
>End Query<
>Info: Test cabinet temperature against lower limit
.
.
.
```

Component End

The Info: lines are comments describing modules. An information line should stand at the beginning of every module. The comments on the program modules are adopted chronologically into the documentation of the program component. In this way the processual function of the program component can be identified. According to the invention, program components with commented program modules are automatically adopted into the documentation of the application program. In the example above, the component documentation would appear as follows:

Documentation:

Timer Component ThreePointController
>Cyclical call every second<
>Test cabinet temperature against upper limit<
>Test cabinet temperature against lower limit<

Timer Component End

It is envisaged according to the invention that there can be superobjects in the shape of forms, called reports. Such prefabricated objects enable the program developer to adopt reports into his application, the resulting programming effort remaining quite limited. There can be one-page and multi-page reports endowed with bibliographical entries. The report objects are superobjects and the report pages are likewise superobjects. Objects called fields can be installed in the report pages. There can be fields to which texts, tables, images or diagrams can be assigned. The report and the pages of the report are created and configured in the on-screen dialog. Objects called fields can be installed in the individual pages of the report and configured in the on-screen dialog. Reports, report pages and field objects are automatically adopted into the menus. Field objects can be endowed with data contents (texts, images and diagrams) with the aid of the >Assign Value< operation. Reports can be opened/closed and printed out in accordance with program instructions. Data contents can be stored as data sets, so that they are available again at arbitrary points in time. The data, for example from test results, can then also be utilized in higher-level databases. The following example demonstrates the options:

```
>Cause Open: Report\Test
>Cause Open: ReportFile\Test(Date)
>Assign Value: Report\Page1\Test\Text.Result = LVResultA<
    .
    .
>Cause Close: Report\Test
>Cause Close: ReportFile\Test(Date)
```

The superobject is >Report\Test<. >Report< is the category and >Test< the name of the report. The corresponding superobject is >ReportFile\Test(Date)<, to which the current data set is written. The file name is made up of the name of the report >Test< and a further name part that contains the current date. The date is supplied automatically. The >Assign Value< operation causes the value of the variable >LVResultA< to be assigned to the field >Text.Result<. In this way, this value is entered into the text field in the report. Now further fields can be written with data. The report and the corresponding file are closed again afterward. The report can then be displayed on the screen and printed out.

It is envisaged according to the invention that there can be superobjects in the form of input screens for the input of recipes or parameters. In this way new options are offered to the software developer with a limited amount of programming effort. Input screens enable the operator to input data as receipts or parameters. Such data are referred to as experimental parameters in research; as test parameters in testing applications; as recipes in mixing processes. These data are characterized in that they must be available before the application is started, because the application is to access these data. Such an application can be a mixing process, a product test or an experiment. It is desirably to be envisaged that data sets containing parameters or recipes can be saved as canned files, so that they can be created ahead of time. Such input screens, also called parameter screens, are superobjects according to the invention. They contain objects. These can be text input objects, selection box (pull-down menu) objects, label objects, table objects. A program developer, if he envisages parameter screens, will position data-input objects in the parameter screen and endow them with the desired properties. Program instructions can then access the data that have been input. Parameters can be saved and loaded with the following instructions:

>Cause Save: ParFile (LVResult)<

>Cause Load: ParFile (LVResult)<

In runtime mode, the operator can select a parameter file or create a new parameter file for >ParFile<. The program continues after the operator input. What is stored in the variable >LVResult< is a value that tells whether the instruction was executed correctly. In this example >ParFile< is the superobject. It is the sum of all parameter files corresponding with the parameter diagram. Each individual parameter file contains a data set that was input in the parameter diagram by an operator. Thus the data content of the superobject >ParFile< is parameter files corresponding with this parameter diagram. It would also be possible, especially in series tests, to specify a test series name and provide the current date or a serial number for purposes of differentiation. For example:

>Cause Save: ParFile\TestName+(Date) (LVResult)<

It is envisaged according to the invention that there is a group of objects called channel objects. Channel objects enable the program to communicate with technical processes. Such channel objects or channels arise through measurement and control chains. Sensors that acquire process data (measurement inputs) serve as sources of the measurement chains. If a process is to be controlled via channels, actuators that can engage controllingly in the process serve as the target. So-called instrumentation and control hardware serves as mediator between the sensors and actuators and the PC. Channel objects are digital and analog inputs and outputs. Channel objects are automatically adopted into menus as soon as they are configured and allotted to the application, so that data (control data) can be written into output channels and data (measurement data) can be read from input channels under instructions. It is important to note that the data are online data. Thus processes can be controlled and monitored in simple fashion. The example that follows shows how an analog measured value can be displayed online in a graphical display object.

>Assign Value: Visu\Output\DigitalDisplay.Temp=Channel\AnalogInput.Temperature<

The function is as follows: The value of the analog display channel object >AnalogInput< named >Temp< (>Channel\AnalogInput.Temp<) is assigned to the digital display (DigitalDisplay) named Temperature, that is, >DigitalDisplay.Temperature< (on the left of the equals sign).

According to the invention there are global objects. All objects heretofore described are application-related. An application can be for example the monitoring and control of an experiment, a mixing process or a test stand. As a rule, however, there can be a number of devices (e.g., mixers) in a fabrication process. A number of experiments can be running in a research institute. In a test bay, a plurality of product tests can be running simultaneously on different test stands. For these reasons, according to the invention, there are projects and applications, a number of applications being assignable to a project. These applications are inherently autarkic. It can happen, however, that operation is to be effected for example from a central computer if quality data for all applications are to be collected and supplied to a central database. In order to make this possible, there are global variables and global objects. All applications can communicate with global objects. Global objects can be installed in visualization screens on a central computer serving as man/machine interface for all applications. A subgroup of global objects comprises global variables. Such variables are available in menus in the applications, so that these variables can be writingly and readingly accessed from all applications. For example:

>AssignValue: GVTemperature-Room3=LVRoomTemperature<

The room temperature stored in the local variable >LVRoomTemperature< is assigned to the global variable >GVTemperature-Room3<. As a consequence, the value of the room temperature of Room3 is globally available. A further example:

>Query If GVStart-Experiment2 = On then<
>Assign Value: ...<
>End Query<

Here, in the application Experiment2, a test is performed to ascertain whether the global variable >GVStart-Experiment2< contains logical >On<. If this is the case, the application Experiment2 can be started. Thus the start signal for starting the application Experiment2 comes from a global higher-level instance.

It is envisaged according to the invention that there are types of program components (procedures) that can be endowed with a distinctive name. In this way it is possible to use a plurality of components of the same type in one program sequence. Further, it is envisaged that a special symbol is assigned to each component type in a structural diagram. In this way the identification of the structure of the program sequence is greatly facilitated. Special attention is directed to the fact that the number of distinct types of program components is small. Further, the component types are subdivided into two categories. In the program sequence, program components in one category are processed serially (chronologically). These are the types Start component, Event component, End component and Sequence component, so that in the structural diagram these are disposed in largely serial fashion. Sequence components, however, can also appear in parallel in the structural diagram. The rule states, however, that in one pass only one of these Sequence components disposed in parallel can be processed. The other category contains components that are disposed in parallel with serial components. The Parallel component type, which can be called by a serial component and works in parallel with other components within a program sequence, belongs to this category. Because the user is presented with only a few types of program components from two categories when creating program code with computer aid, the user is led to structure the task. By virtue of the specified rules for linking program components, the sequence for processing program code composed of individual program components is established automatically. As a result, the software developer receives computer-aided guidance in creating the structure of the application. By using specialized procedures to implement a programming task, the user has available a sort of graphical table of contents.

It is further envisaged according to the invention that there is, as one component type, an Event component, which is always positioned at the beginning of a self-contained program sequence. The Event component is used if the start of this program sequence, which begins with an Event component, is initiated by an event. Such an event can occur in an object of a visualization interface. An event can be the actuation of a virtual switch in the visualization interface. It can, however, also be the exceedance of a limit of a physical quantity. The Event component has an output with which either a serial component of Sequence component or End component type can be called. Which component is called falls to the judgment of the program developer. Further outputs arbitrary in number, with which Parallel components can be called, are available to the program developer. In the structural diagram the Event component has its own symbol, which contains an output that can be linked to a serial component.

It is further envisaged according to the invention that there is, as one serial component type, a Start component, which always stands at the beginning of a self-contained program sequence. It is used when the start of this program sequence is effected by a manual action such as a mouse or keyboard action or by an auto start if this is so set up in the computer operating system. The Start component has an output with which a serial component of Sequence component or End component type can be called. Which component is called falls to the judgment of the program developer. Further outputs arbitrary in number, with which Parallel components can be called, are available to the program developer. In the structural diagram the Start component has its own symbol, which contains an output that can be linked to a serial component. In the system according to the invention, the Start component type in the sequence category is so constructed that it calls another type in the sequence category, except for the Event component type. This can thus be a Sequence component or an End component. What is more, the Start component can also call a Parallel component that is assigned to the parallel category.

It is further envisaged according to the invention that there are, as further serial component types, the Sequence component type and the End component type. The Sequence component is disposed between two serial components. It has at least one input and one output for serial components. By way of the input, the Sequence component can be called by another component (Start component, Event component or Sequence component). By way of the output, the Sequence component can for its part call a serial component of Sequence component or End component type. Sequence components are generally linked in serial fashion by the system, so that it is established that they are processed chronologically. Because of the specified rules described above for linking program components, only one program component of the sequence category can be active in a self-contained program sequence at any specified point in time. It is desirable if the sequences enable conditional branches as already set forth above. In this way, Sequence components can also be disposed in serial fashion in the structural diagram. But only one of the Sequence components disposed in parallel can be called and processed in one pass. The End component is the termination of a sequence. It is the last element of serial components. It has an input for serial components. By way of the input, the End component can be called by another component (Start component, Event component or Sequence component). In the Sequence component and End component there can be further outputs for calling Parallel components. Sequence component and End component have their own symbol in the structural diagram.

It is further envisaged according to the invention that there is, as one parallel component type, a Parallel component, which always has one input with which this component can be called by another component (Start component, Event component, Sequence component, End component or Parallel component) and whose program instructions are processed independently of the calling component, and which in the structural diagram has its own symbol, which has an output with which the component can be linked to another component. The Parallel components make it possible to carry out parallel functions in a self-contained program sequence simultaneously with the processing of serial components, as for example the simultaneous delivery of liquid components to a vessel.

It is further envisaged according to the invention that there can be mutually independent program sequences arbitrary in number, which can run in parallel, a sequence being started by a Start component and further sequences arbitrary in number being capable of being started by Event components. This point also makes clear the distinction from a Parallel component. The latter, while it works in parallel with a sequence, is called by a program component of sequence type via a program call and is thus associated with this sequence.

It is further envisaged according to the invention that in the system according to the invention a symbol is assigned to each of the selected program components and represented in a structural diagram as an aid to the software developer in creating program code. A specified symbol can be assigned to each type of program component for representation in the structural diagram. After the selection of components, the system follows the above-stated program component linking rules in automatically drawing lines to represent serial or parallel processing, so that the structure and flow of the program are represented. In facilitated fashion, the system automatically generates arrows in the lines linking the program structure symbols.

It is further envisaged according to the invention that there can be loops making it possible to run through program components multiple times. Loops over one or a plurality of program components enable the software developer to write well-structured programs when the task is to repeat program sequences. An example of this is inspection procedures in mass production. The inspection cycle is started and run through every time a specimen is presented for inspection. At the end of inspection, the loop makes it possible to return to the initial point of the inspection without exiting the application.

### BRIEF DESCRIPTION OF THE DRAWINGS

In what follows, the invention is described on the basis of an embodiment (system implemented as hardware) with reference to the appended drawings, in which:

FIG. 1 schematically depicts a structure in the form of a data-flow diagram that contains the system according to the invention;

FIG. 2 depicts the operations menu when a new instruction is to be created;

FIG. 3 depicts the example of a menu for objects;

FIGS. 4a to 4h depict the creation of an >Assign Data< instruction;

FIGS. 5a to 5c depict how an object can be replaced with another object;

FIG. 6 depicts program component symbols of the structural diagram;

FIG. 7 depicts an example of a sequence that is started by a Start component; and

FIG. 8 depicts an example of a sequence that is started by an Event component.

### DETAILED DESCRIPTION OF THE DRAWINGS

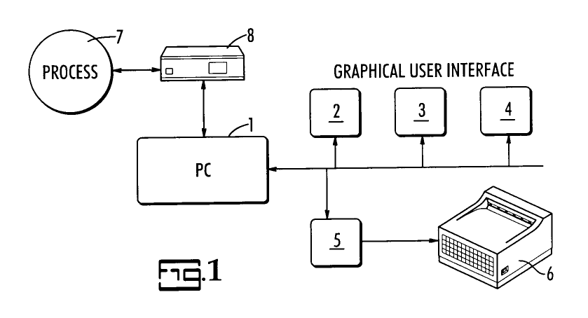

FIG. 1 is a schematic drawing of a system according to the invention having an execution environment for the computer-aided creation and processing of program code. This comprises a PC 1, which exhibits data-processing means in the form of a CPU, memory and input means in the form of a keyboard and computer mouse. Further, PC1 is connected to display means in the form of a screen 2, 3, 4 on which visualization diagrams, parameter diagram and structural diagram are represented. PC1 further exhibits an interface to which instrumentation and control hardware 8 is connected so that the computer unit can communicate outwardly with a process 7. The computer is further linked to a printer 6 via an interface.

Parameter diagram 2 displays parameters input via the keyboard. In this way it is possible to input data that influence the subsequent program sequence. If a created program is currently running, data for a later run can also be input in this way. Thus parameter files for later program sequences can be saved as canned files. Visualization diagram 3 serves first for installing objects during program creation and, further, for observing and operating the objects while an application is running. Structural diagram 4 is essentially useful for structuring the programming task during the creation of program code. If the created program code is being executed, highlighting of program components or their symbols in runtime mode makes it possible to display which program component or components are currently being processed.

User access to created program code, which is also stored in the memory of PC 1, is refused during runtime. In development mode it can be edited via screens 2, 3, 4. Report function block 5 also contains the configuration of data output in the shape of forms that are output by printer 6. In the illustrated embodiment, the system exhibits an environmental interface for linking with sensors and actuators of process 7, with which measured data can be acquired and control signals can be output.

Using the system illustrated in FIG. 1, the user can select, with computer aid, various types of program components in structural diagram 4, which program components are then displayed in the structural diagram. These program components are represented as symbols and can be placed and disposed on the surface in the structural diagram. They are then automatically linked with lines by the system in accordance with specified rules, so that the framework of the program to be created is established. Finally, any arbitrary program can be generated with this computer-aided disposition of program components. Choosing any component or symbol enables access to the program code segment of the component. In summary, FIG. 1 depicts a system that is represented as a data-flow diagram in which the invention is incorporated as function blocks 2, 3, 4, 5.

FIG. 2 depicts the operations menu. This appears if the software developer might wish to create a new instruction. This is effected by clicking with the right mouse button on the line 9 above which the instruction is to be inserted. Possible selections in first level 10 are Script (create instructions) or Edit (copy, insert, etc.) or insert an Info line. If Script is selected, group of operations 11 appears. In order to carry out his processual task, the software developer must decide on one of displayed operation groups 11. This is not difficult because the groups supply him with a mental connection to his processual task. If there should nevertheless be doubt, he can view further levels 12 of the contextual menu. In what follows it is fully set forth what mental associations are necessary in order to select the proper operation.

He will decide on the Query operation group if he might wish to retrieve an item of information. A typical crude instruction that appears if he has decided on an operation in the Query operation group is the following:

>Query If Object <>=Object then<

>End Query<

He will decide on the Assign operation group if he might wish to assign to one object data that are stored in another object or if he might wish to format data or assign a data type to data. A typical crude instruction that appears if he has decided on an operation in the Assign operation group is as follows:

>Assign Data: Object=Object<

He will decide on the Cause operation group if he might wish to alter the state of a superobject (e.g., Open/Close, Start/Stop, Create/Delete) and if he might wish to transfer data sets from one superobject to another. A typical crude instruction that appears if he has decided on an operation in the Compare operation group is the following:

>Cause Open: Superobject<

He will decide on the Control operation group if he might wish to intervene controllingly in the program sequence. This can take the form of program component calls, repetitions or wait cycles. A typical crude instruction that appears if he has decided on an operation in the Control operation group is as follows:

>Control Call: Object<

He will decide on the Configure operation group if he might wish to make a change in the appearance of a graphical object or the configuration of an interface. A typical crude instruction that appears if he has decided on an operation in the Configure operation group is the following:

>Configure: Object (Property)=Var<

Here the keyword Property is a subobject and relates to the keyword Object, which is usually a graphical object. Var is a keyword that can be replaced with a variable, constant, fixed value or formula.

In summary, the following mental associations are involved in creating a new instruction:

| | | |
|---|---|---|
| Retrieve information | → | Query operation |
| Assign data to an object | → | Assign operation |
| Access superobjects | → | Cause operation |
| Control program sequence | → | Control operation |
| Appearance of an object | → | Configure operation |

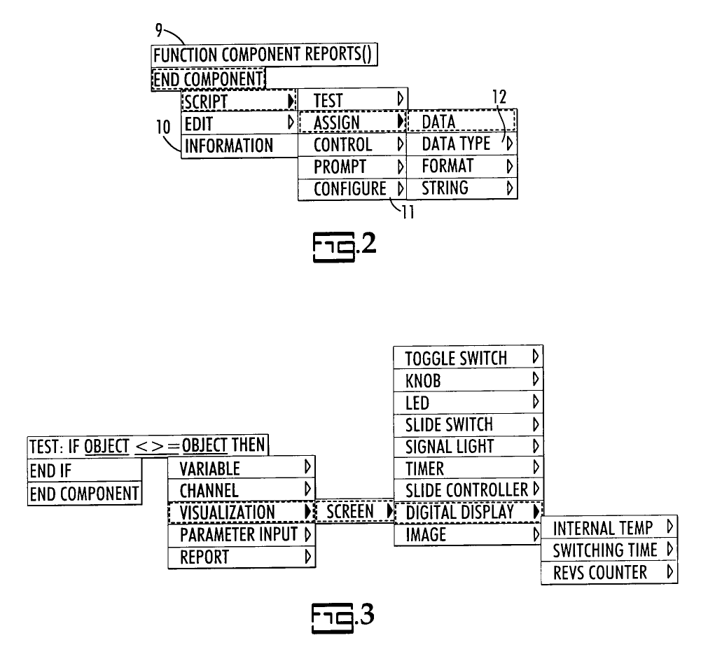

FIG. 3 depicts the example of a menu for objects. The next step toward further completion of an instruction, after which the operation has been established, is the selection of objects. This step will not pose much of an intellectual challenge to the software developer, because he has previously installed the superobjects and objects displayed in the menu. The displayed menu contains the menu items that can replace the keyword Object on the left of the operand <>=. Level 13 contains the categories of objects. These are shown in bold letters in the finished instruction. They serve as anchors if the selected object is subsequently to be replaced by another. Level 14 is the level of superobjects. As explained in the patent description, superobjects contain objects. These are diagrams that are installed and endowed with distinctive names (Screen1 and Screen2). Objects and superobjects are installed independently of the script. They will not appear in the menus until they are installed. Level 15 contains object types. The LED object type has been selected. LEDs are small (virtual) signal indicators that can be turned on and off. This level is necessary because a plurality of objects from each object type can be positioned in one diagram. Level 16 then displays the objects for selection with their distinctive names. Here a number of LEDs (LED_1 to LED_8) are ready for selection. If one follows the highlighted path in the menu of FIG. 3, it is easy to see how the instruction will appear upon the selection of the object >LED_1<, namely:

>Query If Visu\Diagram. Screen\LED.LED_1=<>Object then<

>End Query<

In order to finalize, the operand and the keyword Object on the right of the equals sign must still be replaced. A finished instruction can then read:

>Query If Visu\Diagram. Screen\LED.LED_1=On then<

>End Query<

The condition tested here is whether the LED named >LED_1< is turned on.

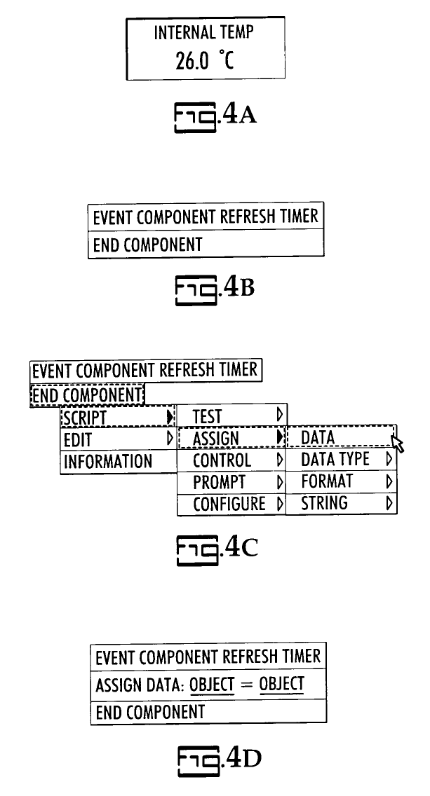

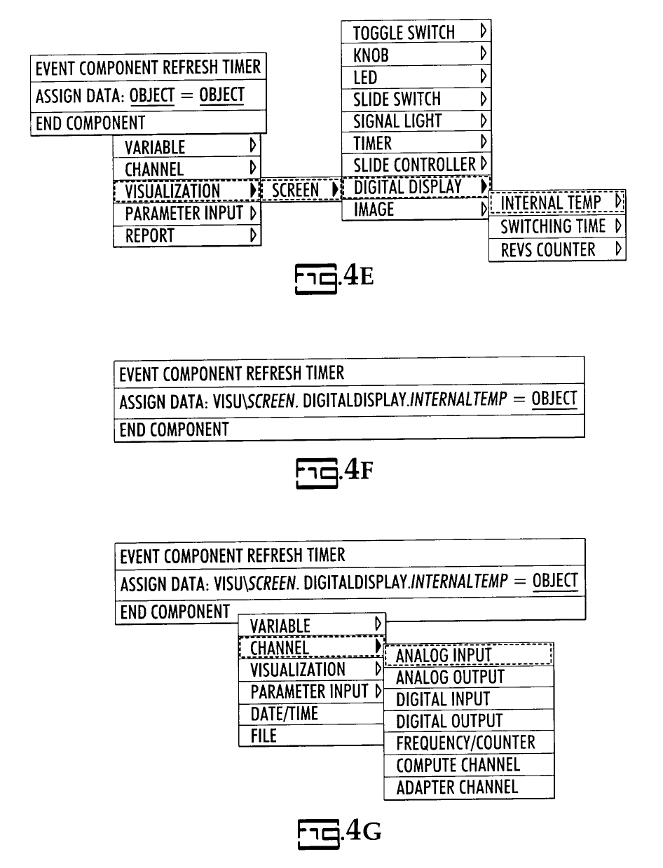

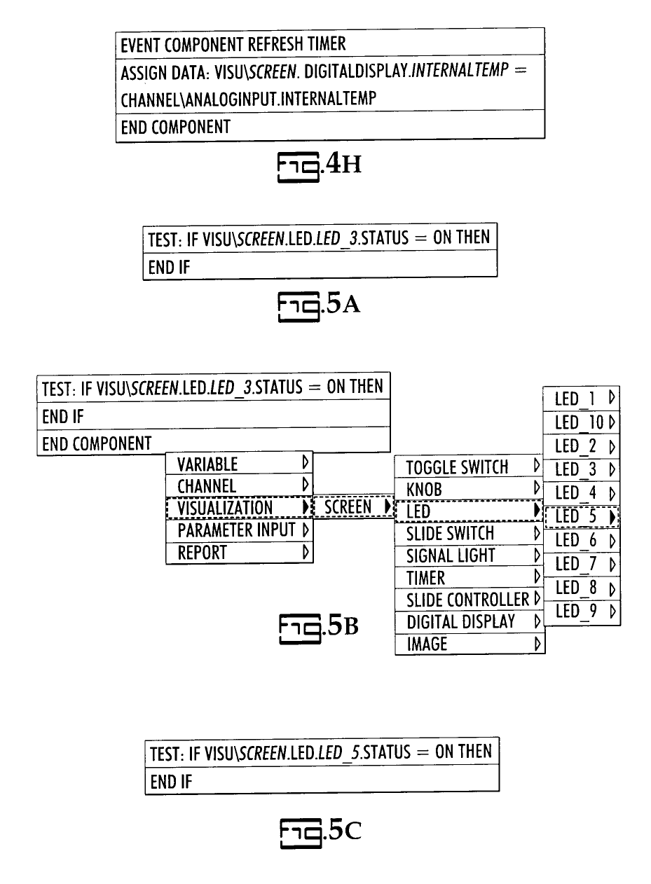

FIGS. 4a to 4h depict how an instruction having an >Assign Data< operation is created. The task of the instruction is to display the value of the internal temperature on a (virtual) digital display device (FIG. 4a). A prerequisite is that the digital display device of FIG. 4a has been previously installed in a diagram. This is effected by dragging the object from the symbol bar onto the screen and positioning it. It can then be endowed with properties such as appearance and name under an on-screen dialog. A further prerequisite is that an Event component as depicted in FIG. 4b has been created. This is effected by creating an Event component named >Refresh<, the component being executed automatically after every 1000 milliseconds. Now the >Assign value< instruction can be created. The result should be as follows:

>Assign Value: Visu\Diagram. Screen\DigitaiDisplay.InternalTemp=Channel\AnalogInput.Temp<

In plain language this instruction says the following: The value of the channel >AnalogInput< named >Temp< is assigned to the (virtual) digital display device of FIG. 4a, that is, the >DigitalDisplay< named >InternalTemp< in the diagram >Screen<. As a result of the assignment, the value of the analog channel >Temp< is automatically displayed. The creation of the instruction is illustrated in the subsequent steps, the digital display object named “InternalTemp” (FIG. 4a) having been created previously and a timer object named “Refresh” having been created so that an Event component (FIG. 4b) has been created, as described above. The program module is now inserted into the Event component of FIG. 4b. These steps follow:

Step 1 (see FIG. 4c): Select the operation >Assign Data<.

The crude instruction of FIG. 4d is displayed.

Step 2: Replace the keyword Object on the left of the equals sign as depicted in FIG. 4e.

The object on the left of the equals sign has been replaced as depicted in FIG. 4f.

Step 3: Replace the keyword Object on the right of the equals sign as depicted in FIG. 4g. The object on the right of the equals sign has now been replaced as depicted in FIG. 4h. The instruction is now finished.

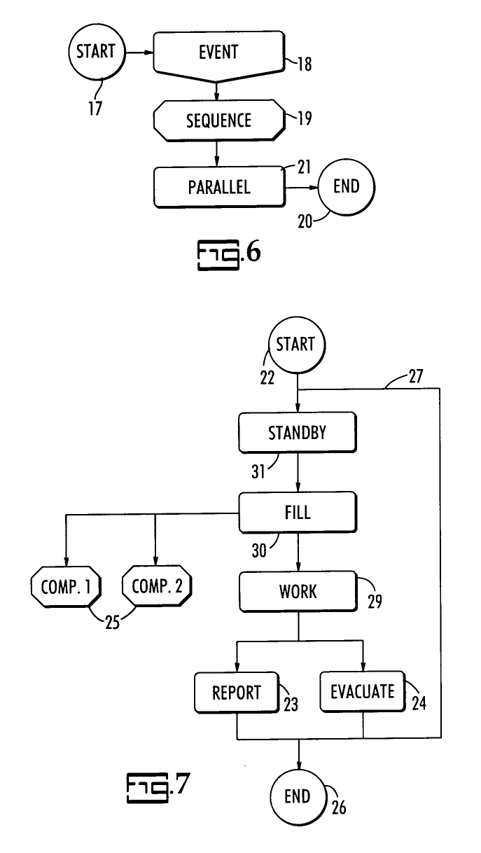

FIGS. 5a, 5b and 5c depict how an object can be replaced with another object.

In the instruction depicted in FIG. 5a, >LED_3< is to be replaced with >LED_5<.
Left-clicking on the bold-faced word >Visu< (FIG. 5b) causes the object menu to open. Now >LED_3< can be replaced with >LED_5<. In the instruction depicted in FIG. 5c, >LED_3< has been replaced with >LED_5<.

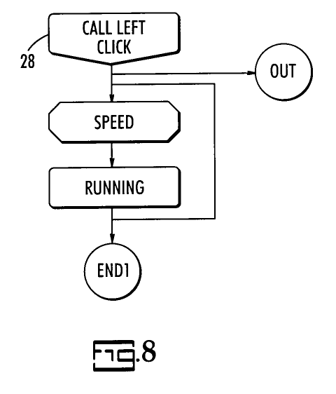

FIG. 6 depicts a plurality of symbols as employed in a structural diagram, each representing one program component. The following types belong to the sequence component category: Sequence component 19, Event component 18, Start component 17 and End component 20. Sequences are linked in serial fashion by the system, so that they operate chronologically. Thus, at any given point in time, only one component from the sequence category can be active. Sequences enable conditional branches.

In addition, the figure also depicts a Parallel component type, or rather its symbol 21, which belongs to the parallel component category. Parallel components perform tasks that are executed simultaneously, that is, in parallel with sequences.

In the programming system according to the invention, program components can be linked in accordance with specified rules. Start component 17, for example, calls another component type in the sequence category, except for Event component 18. This can be a Sequence component 19 or an End component 20. Furthermore, Start component 8 can also call a Parallel component 21. Event component 18 is called by events that can occur in the flow of the program and can in turn call a Sequence component 19, an End component 20 or a Parallel component 21. A sequence can therefore be started by a Start component 17 or an Event component 18. An event that triggers the start of a sequence can be for example the choice of an operating object in a visualization diagram. The linking rules implemented further establish that Sequence component 19 can be called by a Start component 17, an Event component 18 or a Sequence component 19 and in turn can call a Sequence component 19, an End component 20 or a Parallel component 21. What is more, conditional branches are possible in sequences. The linking rules of the embodiment described say further that End component 20 forms the termination of a sequence. This is called by a Start component 17, an Event component 18 or a Sequence component 19. It can in turn call a Parallel component 21. This Parallel component 21 operates in parallel with sequences. It is called by a Start component 17, an Event component 18, a Sequence component 19 or an End component 20. Parallel component 21 itself cannot call any program component. The system presents the user with only the stated types of program components for selection, which types can be divided into sequence and parallel categories. As illustrated in FIG. 6, these selected program components are then displayed in the structural diagram by means of associated symbols, which can be endowed by the user with a designator such as a name.

FIG. 7 now depicts a structural diagram in which the system has automatically linked the program components together with lines so as to elucidate the flow and structure of the program. Whenever a further symbol representing a program component is created by the user in the structural diagram, the link to the calling symbol is automatically made by the system according to the invention in dependence on the type of the new component and in accordance with the specified rules. Depicted symbols 22 to 26 serve to represent the associated program components. In accordance with the program component linking rules stated above, symbols 22 to 26 are automatically linked with lines so as to reflect the program sequence and program structure. The arrows in the lines linking the symbols elucidate the program sequence. The program structure is moreover represented by the substantially vertical disposition of serially linked Sequence components 22, 23, 26 and 27, while Parallel components 25, working in parallel, are disposed horizontally with respect to the calling Sequence component “Fill.” The linking lines to Parallel component 25 run substantially horizontally, a vertical offset being necessary because of the disposition of the symbols. The lines linking Sequence components 22, 23, 24, 26 run substantially vertically, a horizontal offset being necessary because of the disposition of the symbols.

The symbols of the structural diagram in FIG. 7 serve as virtual containers for the respective program code segment. The program code segment is accessed by clicking on the symbols. A window thereupon opens in which the program code segment can be edited. The system according to the invention, in the embodiment described, furnishes a development mode and a runtime mode, the created program code being processed in the latter. Upon the start of the program, in accordance with the illustration in FIG. 7, the first program code segment processed is the one associated with Start component symbol 22. The Sequence component Work can call either Sequence component 23 or Sequence component 24. To this end there is a conditional branch in the program code segment of Sequence component 29, which conditional branch ensures that either Sequence component 23 or Sequence component 24 is called. As illustrated in FIG. 7, Sequence component 30 conditionally or unconditionally calls one and/or the other Parallel component 25. Its program code segment is processed in parallel with the sequence of the serial program components. Parallel components 25 differ from the subprocedures known in conventional programming languages. Such subprocedures interrupt the program sequence. In contrast, Parallel component 25 is processed in parallel with the calling program part and thus constitutes a novel element. This Parallel component can advantageously be utilized in the case of time-consuming procedures, which can then run in parallel. Depending on the application, the calling program component can exchange data with the called program component. Each of Sequence components 23, 24 calls End component 26 or, via loop 27, Sequence component 31 as dictated by a condition. Program parts that must be executed before the termination of the program can be stored in End component 26. A software developer can envisage that results are stored and reports generated in End component 26 (FIG. 1).

FIG. 8 depicts a structural diagram having a sequence that is started by an Event component 28. Event component 28 is called by events that can occur in the program sequence and can in turn call a Sequence component, an End component or a Parallel component. Such events can be for example operator actions that are triggered by clicking on visualization objects in visualization diagrams. Such events can occur at any time during the runtime of the program created. Event component 28 starts a sequence that differs from a sequence according to FIG. 7 only in the way in which it is started. While a sequence illustrated in FIG. 7 can occur only once in an application, sequences according to FIG. 8 can occur in arbitrary number and are executed in parallel (event-dependent) fashion. These sequences according to FIG. 8, which are started by Event component 28, operate independently of one another and also independently of a sequence according to FIG. 7, which is started by a Start component 22. This also elucidates the distinction to Parallel components 25. While these do operate in parallel with a sequence, they are, however, called by a program component of Sequence type and are thus associated with this sequence.

What is claimed is:

1. A computer-aided method for imperative programming of computers, having program code comprising a plurality of program instructions, there being keywords (placeholders) and menus (contextual menus), having a graphical user interface, wherein program instructions are composed of operations and objects, objects being addressable and operations and objects being selected from menus.

2. The method of claim 1 wherein operations access object data and operations influence objects and program sequences.

3. The method of claim 1 wherein there are superobjects, objects and subobjects, superobjects being capable of containing further superobjects, objects and data sets (databases, files), objects contain data and subobjects contain data, subobjects relating to a superobject, to an object or to an operation.

4. The method of claim 1 wherein, in the process of generating a new instruction, an operation is selected from a menu, so that a crude instruction is displayed that contains the concept of the chosen operation as well as keywords with which menus can be called, so that superobjects or objects and, on a case-by-case basis, subobjects can be selected.

5. The method of claim 1 wherein groups of operations are available for the selection of operations, which groups of operations enable inquiries, can assign data to objects, can influence superobjects, can control program sequences and can alter the appearance of objects.

6. The method of claim 1 including a “Query If” operation group which has the task of comparing object data so that a condition is derived in such fashion that corresponding instructions are executed if the condition is true and not executed if the condition is false.

7. The method of claim 1 including an assign operation group which has the task of enabling data exchange between objects and can have the further tasks of assigning a format or a data type to data.

8. The method of claim 1 wherein objects include super objects and including a cause operation group which has the task that superobjects can be opened and closed, that superobjects can be created and deleted, that superobjects can be started and stopped, that a test can be performed to ascertain whether superobjects are present, that superobjects can be copied and inserted, that superobjects can exchange data among themselves.

9. The method of claim 1 including a control operation group which has the task that program components can be called, that there can be wait cycles in the program sequence, that there can be repeat instructions (loops).

10. The method of claim 1 including a configure operation group which makes it possible to alter properties of graphical objects including size, color, visible/hidden and which interfaces in an adjusting manner with other programs and outside devices so as to enable communication.

11. The method of claim 1 including menus for superobjects and objects, whose selectable menu items relate to a selected operation, said menu having been previously installed by a software developer.

12. The method of claim 1 including menus for superobjects and objects, whose selectable menu items relate to the selected operation and are specified by a language design.

13. The method of claim 1 wherein, if the object is a file, a directory can be displayed in runtime mode instead of a menu, from which directory the operator can select a file.

14. The method of claim 1 wherein the instructions include block instructions having an initial line and a final line, said block instructions containing an operation and objects that relate to objects that are contained in instructions insertable into the block instruction.

15. The method of claim 1 wherein said instructions can be incomplete instructions that contain an operation but no objects, said operation relating to objects that are contained in instructions other than said incomplete instructions.

16. The method of claim 1 wherein there is a keyword (Var) that, in its menu, contains as objects variables, constants, formulas and fixed values as replacement for the keyword.

17. The method of claim 1 wherein, when an object is incorporated into a hierarchical structure, a path is associated with the distinctive name of the object, which path together with the distinctive name is inserted into the instruction through replacement of the keyword.

18. The method of claim 1 wherein, after the replacement of a keyword by an instruction segment, there is a highlighted point in said instruction segment with which the menu with which the instruction segment was created can be recalled.

19. The method of claim 1 wherein instructions in the form of modules can be created, the individual modules being capable of being endowed with a comment in the form of information lines, said information lines being automatically adopted into a program component documentation and said program component documentation being automatically adopted into an application program documentation.

20. The method of one of claim 1 including superobjects in the shape of forms and report objects and wherein said report objects in turn contain objects that are activated and configured under an on-screen dialog, and are automatically adopted into said menus so that, under said program instructions, they are endowed with data including texts, images and diagrams, and wherein said data are stored as data sets.

21. A computer-aided system for imperative programming of a computer, with an operating system, comprising:
program code including a plurality of program instructions, keywords placeholders in the form of keywords contextual menus,
a graphical user interface including
objects in the form of input screens for showing structural diagrams and wherein data-input objects including text input objects, selection box objects, label field objects and table objects are positioned in said screens, said objects being automatically adopted into the menus as soon as they have been installed and endowed with properties, whereby the input data are accessable in accordance with instructions, and wherein the input data are stored in the form of data sets.

22. The system of claim 21 including menus and channel objects including digital, analog input/output objects which are automatically adopted into said menus, whereby said channel objects are writingly accessable as output objects and readingly accessable input objects under instructions.

23. The system of claim 21 including global objects in the menus of the individual applications of a predetermined project and in a higher-level application, whereby the applications of the project are writingly and readingly are selectively accessible.

24. The system of claim 21 including program components in the form of procedures and identified as to type and endowed with a distinctive name, and a special symbol associated with each said type, said symbols being represented in structural diagrams, and a category of serially linked components including start component, event component, end component and sequence component which are processed chronologically, and components disposed in parallel, which are processed in parallel with other components within a program sequence and are subject to call by another component.

25. The system of claim 21 including an event component of a serial component which always stands at the beginning of a self-contained program sequence if the start of a program sequence is triggered by an event, and which has an output with which a serial component of one of a sequence component and an end component can be called, and to which further outputs can be added with which function components can be called, and wherein said event component has its own symbol in a structural diagram having an output linkable to a serial component.

26. The system of claim 21 having parallel components, serial components including a start component at the beginning of a self contained program sequence, when said program sequence is started by a one of a manual action and a auto start action, said computer having an output with which one of a serial component and a end component can be called and to which additional outputs can be added so as to call parallel components and wherein said start component has its own symbol in a structural diagram having and output to which a serial component can be linked.

27. The system of claim 21 having serial components including a sequence component, a start component, an event component, and an end component, said sequence component being disposed between two serial components and having an input with which this component can be called by another serial components and an output with which one of said sequence component and end components can be called, said end component being disposed at the end of a sequence, and which has an input with which this component can be called by another of said serial component it being possible to add to the sequence components and End components further outputs with which parallel components are called, and wherein said components have their own symbols in said structural diagram.

28. The system of claim 21 including a parallel component having an input by which it can be called by one of a start component, event component, sequence component, end component and parallel component, and wherein program instructions are processed independently of the calling component, and wherein said parallel component has its own symbol in said structural diagram, with an input by which said parallel component can be linked to another component.

29. The system of claim 21 wherein there are mutually independent program sequences which run in parallel, a sequence being started by a Start component and a second plurality of sequences which are capable of being started by said event components.

30. The system of claim 21 wherein standardized symbols are associated with the types of program components, wherein these symbols are linked with lines in a structural diagram in accordance with fixed rules, so that the program structure and program sequence are reflected.

31. The system of claim 21 including loops that make it possible to run program components multiple times.
